(19) United States
(12) Patent Application Publication
(10) Pub. No.: US 2012/0072230 A1
(43) Pub. Date: Mar. 22, 2012

(54) IDENTIFICATION AND NULLIFICATION OF SUBSTANCES

(75) Inventors: Suyash S. Jape, Maharashtra (IN); John G. Musial, Newburgh, NY (US); Abhinay R. Nagpal, Maharashtra (IN); Sandeep R. Patil, Elmsford, NY (US)

(73) Assignee: INTERNATIONAL BUSINESS MACHINES CORPORATION, Armonk, NY (US)

(21) Appl. No.: 12/883,523

(22) Filed: Sep. 16, 2010

(51) Int. Cl. G06Q 50/00

(52) U.S. Cl. 705/2

(57) ABSTRACT

Substance identification and nullification processes are provided. A process includes identifying a substance on an object, the substance determined to be associated with a health risk. The process also includes identifying a treatment plan for nullifying the substance, the treatment plan prescribing a solution and instructions for nullifying the substance using the solution. The process further includes preparing the solution identified in the treatment plan, and implementing the treatment plan with respect to the object.

### BACKGROUND

The present invention relates to health and safety systems, and more specifically, to substance detection, identification, and nullification.

In industrial environments, hands are the highways to the transmission and spread of dangerous chemicals that cause disease, illness, and infection. Hands often become contaminated with substances that cause respiratory, intestinal, nervous system damage and other diseases, either directly or through contact with contaminated surfaces.

Since many viruses and infections are spread by touch, washing and sanitizing hands before touching foods or other persons is one of the best ways to help stop the spread of these viruses and infections. Studies conducted by the Centers for Disease Control and Prevention and by several other groups found that nurses and doctors fail to wash their hands using industry-recommended practices 60% of the time between contacts with patients, as well as between medical procedures.

Industrial workers handle chemicals and contaminants. If a worker does not properly wash, remove, or decontaminate hands and skin after leaving the work area, he/she can spread the contaminants outside of the industrial work zone, e.g., to coworkers and to cars, homes, and family. For example, many businesses in the car wash industry use hazardous materials, and their employees may be regularly exposed to what are believed to be cancer-causing toxic chemicals in car cleaning products. Prolonged exposure to some of these chemicals can also contribute to liver, kidney, heart, and central nervous system damage.

Even if these chemicals are not transmitted to other individuals through contact, they may still present health risks for persons who are exposed to these chemicals if they are not adequately removed.

### SUMMARY

According to one embodiment of the present invention, a method for substance identification and nullification is provided. The method includes identifying a substance on an object, the substance determined to be associated with a health risk. The method also includes identifying a treatment plan for nullifying the substance, the treatment plan prescribing a solution and instructions for nullifying the substance using the solution. The method further includes preparing the solution identified in the treatment plan, and implementing the treatment plan with respect to the object.

A system for substance identification and nullification includes a computer processor and an application executing the computer processor. The application identifies a substance on an object, which is determined to be associated with a health risk. The application identifies a treatment plan for nullifying the substance. The treatment plan prescribes a solution and instructions for nullifying the substance using the solution. The system also includes a treatment apparatus in communication with the computer processor. The treatment apparatus prepares the solution identified in the treatment plan, and implements the treatment plan with respect to the object.

A computer program product for substance identification and nullification is provided. The computer program product includes a computer-readable storage medium having instructions embodied thereon, which when executed by a computer processor cause the computer processor to implement a method. The method includes identifying a substance on an object, the substance determined to be associated with a health risk. The method also includes identifying a treatment plan for nullifying the substance, the treatment plan prescribing a solution and instructions for nullifying the substance using the solution. The method further includes preparing the solution identified in the treatment plan, and implementing the treatment plan with respect to the object.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description, taken in conjunction with the accompanying drawings, in which:

FIG. 1 depicts a block diagram of a system upon which substance identification and nullification may be implemented in an exemplary embodiment;

FIG. 2 illustrates a flow diagram describing a process for implementing the substance identification and nullification in an exemplary embodiment; and

FIG. 3 depicts database tables of substances, treatment plans, and physical locations relating to the substances and treatment plans that are used in implementing the substance identification and nullification in an exemplary embodiment.

### DETAILED DESCRIPTION

In an exemplary embodiment, the substance identification and nullification provides intelligent substance, detection, identification, and nullification processes that address a variety of chemical or pathogenic threats known to industries, manufacturing plants, hospitals and laboratories, and makes optimum use of expensive cleansing solutions, reduces cleaning costs, and provides the best possible safety. Substances that are subject to the exemplary identification and nullification processes refer to any solution or material that can be harmful to humans when consumed (e.g., ingested or inhaled) or through extended contact with skin. Industry solvents or chemicals used in the manufacture of products in a particular industry plant may include, e.g., sodium lauryl sulfate (SLS), sodium laureth sulfate (SLES), propylene glycol, dioxane, dioxin, bentonite, propylene glycol, diethanolamine (DEA), polyethylene glycole (PEG), benzylphanone, sodium benzoate, glycerin, collagen, etc. In an exemplary embodiment, a substance is described herein as being a component of a composite material that is used for a defined purpose within a particular environment (e.g., a working environment, such as an institution, manufacturer, or any entity that engages in the use of hazardous materials). For example, where the composite material (i.e., a combination of ingredients used in formulation for a particular purpose) is a cleaning solvent, the substance may be a chemical typically found in a cleaning solvent, such as sodium lauryl sulfate. While the composite material may contain several ingredients, many of which are considered inert, it is beneficial to understand the properties of the composite material in terms of the types of substances known to have health risks associated thereto.

Hand washing guidelines are often set by regulatory agencies for industrial units, hospitals, and chemical plants. Hands can be cleaned by soap and water, industrial cleaning products, such as phosphoric acid-based, non-ionic cleaners, degreasers, and safety solvents, which can neutralize the harmful chemicals on hands.

For different types of contaminants, different sanitization measures are applicable. Hand washing systems provide an automatic hand washing mechanism with detection of when hands are put below the tap, spraying of cleaning acids/alkali, safety solvents, application of a specified water temperature, and duration of wash.

Many chemical contaminants are not entirely disposed of with common soaps or cleaning solutions. Due to lower costs of general cleaners, industries often rely on general cleaners with conventional product formulations to reduce operational costs and avoid wastage of expensive cleaning chemicals.

There are also deficiencies in current tap wash systems with respect to chemical identification while cleaning hands and other objects. There are also deficiencies in terms of identifying (on hands or other items) harmful contaminants such as solvents, herbicides, and pesticides, and industrial materials such as lead, asbestos and fiberglass in industrial, institutional, and even residential environments.

In an exemplary embodiment, the substance identification and nullification uses the science of molecular computation identification (MCID). Molecular computation identification (MCID) is a technology used to identify molecules using photonic emissions from the molecules. These molecules are known to emit photonic signals corresponding to their composition. Photonic emissions are stimulated from a molecule using a chemical, or a mix of chemicals, that cause light to be emitted from the molecule. The character of the light can be used to identify the molecule that emitted the light.

The process of preparing a substance for identification using MCID begins with imbuing the substance with fluorescent dyes that act as molecular logic gates. In this embodiment, the substance, or composite material that includes the substance, may be imbued with fluorescent dyes prior to the composite material being used in a working environment. In an alternative embodiment, at the time in which decontamination or nullification is desired, e.g., at the end of a procedure in the environment or at the end of a work day, the fluorescent dyes may be applied to the object subject to decontamination. For example, at the end of the work day, an individual who worked a composite material containing a hazardous substance may place his/her hands under a faucet or applicator of a treatment apparatus, whereby the treatment apparatus sprays or applies the fluorescent dyes (and related washes) to the individual's hands. These embodiments are described further herein.

Using the MCID process, each dye used is a single logic gate with one chemical input and one fluorescence output in a chosen color. For a given emission color, excitation color, and chemical input, four logic tags are provided. To identify a substance, it is first washed in a solution, such as an acid, and its fluorescence is observed. It is later washed with an alkali and its fluorescence is again observed. The fluorescence output pattern describes which type of logic tag is attached to the substance.

The exemplary substance identification and nullification processes provide an intelligent hand cleaning and sanitizing system, method, and apparatus that enable the detection of harmful chemicals on hands and other objects such as toys. Different disinfection methods are applied to hands and objects depending on the chemicals detected via MCID.

In one embodiment of the invention, while washing hands, toys and other objects (all of which are referred collectively as ‘objects’), a method for spraying the object under the tap with fluorescent dyes followed by acidic and alkali solutions to classify the MCID of the substance on the surface is performed. A photonic signal is received wherein the photonic signal includes a frequency and amplitude.

The substance identification and nullification processes may further include searching for the identifier (MCID) that was received in a predefined stored list comprising identifier-quantity pairs, wherein a frequency and amplitude corresponds to each identifier. The identifier refers to the name of the substance subject to identification by the exemplary identification and nullification processes. The quantity refers to the frequency and amplitude of a photonic signal.

The substance identification and nullification processes may also include storing and querying a record using a web service indicating that the chemical substance is dangerous if the frequency and amplitude of the photonic signal matches the frequency and amplitude corresponding to the first identifier-quantity pair.

The exemplary treatment apparatus then prepares the appropriate disinfecting solution with ingredients available or applies the available disinfectant corresponding to the chemical contaminants on the washed object, directs an applicator component of the apparatus to spray the solution on the object under the applicator component, along with instructions given to the user to follow further procedures, e.g., washing for a minimum duration required for the disinfectant to nullify or neutralize the harmful chemicals.

As indicated above, the substance identification and nullification processes provide for the detection, identification and nullification of substances by embedding molecules in these substances, which may be potentially hazardous chemical materials used in industrial processes and manufacturing plants, whereby these molecules are used for identifying individual cells or nano-devices. Upon scanning the potentially hazardous materials, the embedded molecules act as tiny ID tags that use the presence of a chemical, or a mix of chemicals (e.g., potentially hazardous materials), as inputs, and give off light or sonar signatures as output. The output of these molecules may be read by a reader, or scanner, which may be used to identify the type of material as well as the amount of the material present on hand and washed objects.

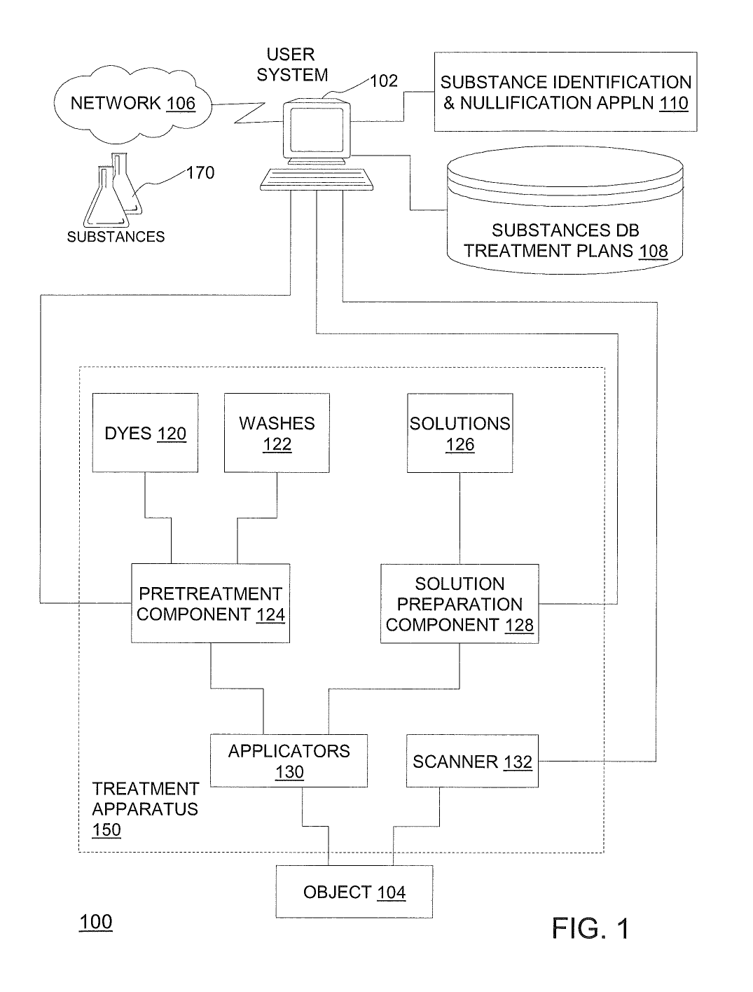

Turning now to FIG. 1, an exemplary system upon which the substance identification and nullification processes may be implemented will now be described.

The system of FIG. 1 includes a user system 102 in communication with a network 106 and a treatment apparatus 150. The user system 102 executes computer instructions for performing the substance identification and nullification features described herein. The user system 102 is also communicatively coupled to a storage device 108.

The user system 102 represents a computer processing device through a user may perform the substance identification and nullification. The user system 102 may be implemented using a general-purpose computer executing a computer program for carrying out the processes described herein. The user system 102 may be a personal computer (e.g., a lap top, a personal digital assistant) or host-attached terminal.

The network 106 may be any type of known networks including, but not limited to, a wide area network (WAN), a local area network (LAN), a global network (e.g. Internet), a virtual private network (VPN), and an intranet. The network 106 may be implemented using a wireless network or any kind of physical network implementation known in the art.

The storage device 108 includes a data repository with data relating to managing the substance identification and nullification services and may be implemented using a variety of devices for storing electronic information. It is understood that the storage device 108 may be implemented using memory contained in the user system 102 or that it may be a separate physical device (e.g., as shown in FIG. 1). Information stored in the storage device 108 may be retrieved and manipulated via the user system 102.

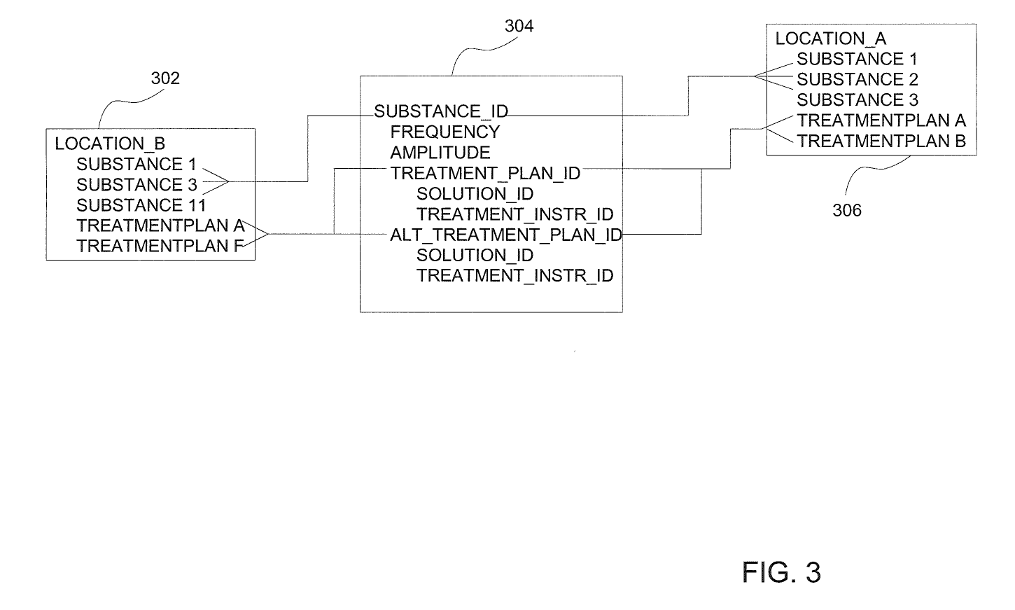

The data repository includes one or more databases containing documents, files, and related data in support of the substance identification and nullification services. In an exemplary embodiment, the storage device 108 stores a database of known substances. The storage device 108 may also store treatment plans 108. Treatments plans specify a course of action to be taken to nullify a particular substance. For example, a treatment plan may specify the type of solution to be applied, the manner of application of the solution, the duration of time for which the solution should be left on the object, and other actions. In alternative embodiments, some or all of these treatment plans may be stored at a remote location and accessed over network 106 (via a third party system over the web). Sample database records of substances, treatment plans, and related tables are shown and described in FIG. 3.

The user system 102 may operate as an application server to other user systems that may be coupled to the network 106. The user system 102 executes one or more computer programs to provide the substance identification and nullification services. As shown in FIG. 1, the user system 102 executes a substance identification and nullification application 110 (also referred to herein as “application”) for implementing the substance identification and nullification services described herein. The application 110 may also include a messaging component for alerting the user system 102 upon detection of a hazardous substance, as will be described further herein.

In one embodiment, the application 110 provides a user interface (not shown) that enables users to enter newly classified substances and/or changes to treatment plans.

In an exemplary embodiment, the treatment apparatus 150 includes dyes 120, washes 122, solutions 126, a pre-treatment component 124, a solution preparation component 128, an applicator 130, and a scanner 132. The treatment apparatus 150 also includes a scanner 132. Also included in the system of FIG. 1 is an object 104 and composite materials that include one or more hazardous substances 170.

In one exemplary embodiment, the process of preparing a composite material (or substances thereof) 170 for identification using MCID begins with imbuing the composite material 170 with fluorescent dyes 120 that act as molecular logic gates. Each dye 120 used is a single logic gate with one chemical input and one fluorescence output in a chosen color. For a given emission color, excitation color, and chemical input, four logic tags are provided. To identify a substance 170, it is first washed in a solution 122, such as an acid, and its fluorescence is observed. It is later washed with another solution 122, e.g., alkali, and its fluorescence is again observed. The fluorescence output pattern describes which type of logic tags is attached to the substance. By employing different logic types in different combinations in the substance 170, different chemical inputs and different excitation and observation wavelengths, it is possible to generate millions of distinguishable tags. The final MCID tag address of a given substance 170 can be read sequentially from left to right. For example, excitation wavelength, emission wavelength, logic type and combination, inputs, and binding threshold for each input, is read. Fluorescent dyes such as rhodamine 6G (R6G), MitoTracker Green (MTG) can be used for MCID.

The available readings can either be in the local memory (e.g., storage device 108) of the user system 102 or can be retrieved and compared at runtime with known readings in trusted databases, such as the World Health Organization repository or other life science organizations over network 106 through web services.

In an exemplary embodiment, the treatment apparatus 150 enabled with MCID components and is integrated with user system 102. The MCID components include a fluorescence or photonic scanner 132 and instruments to perform MCID analysis of chemicals on a surface of an object 104, whereby one applicator 130 sprays or applies the surface of the object 104 with fluorescent dyes 120, as well as acidic and alkali solutions 122, and another applicator 130 receives and applies various solutions 126, which have been prepared by the solution preparation component 128 based upon a prescribed treatment plan. In an exemplary embodiment, the applicators 130 and scanner 132 may be activated via a sensor (not shown) that is placed in closed proximity of the applicators 130 and scanner 132, whereby when the sensor detects the presence of the object 104 (or alternatively, substances 170), a corresponding action is performed by the scanner 132 and/or applicators 130.

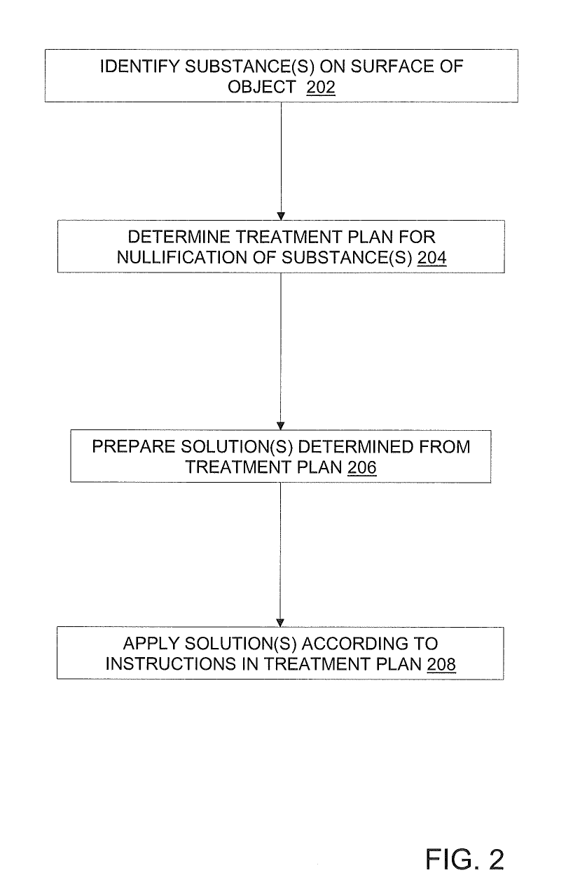

Turning now to FIG. 2, an exemplary process for implementing the substance identification and nullification system and apparatus will now be described. For purposes of illustration, it is assumed that the fluorescent dyes have not been applied to the composite material, or substances 170 prior to use of the composite material in the environment.

At step 202, the scanner 132 scans the object 104 to determine a particular substance. Since the substances 170 have not yet been imbued with the dyes, the treatment apparatus 150 may apply these dyes as will now be described. The fluorescent dyes 120 may be applied to a surface of the object 104 whereby the dyes 120 act as molecular logic gates. An acidic wash 122 may then applied to the surface of the object 104 at step 204, and the scanner again 132 observers the fluorescence, excitation color corresponding to the acidic solution 122 at step 206.

An alkali wash 122 may then be applied to the surface of the object 104, and the scanner 132 observes the output fluorescence, which output is sent to the user system 102. Each dye 120 acts as an input to the application 110, and fluorescence output (photonic signal, excitation color) acts as an identification of the substance 170.

In an exemplary embodiment, the scanner 132 transmits the photonic signal to the application 110, which in turn, analyzes the photonic signal by comparing fluorescence outputs with the available set fluorescence readings of various known chemical contaminants (i.e., the substances stored in the database of storage device 108). Readings of potentially harmful chemicals are made available either by gathering a fluorescence reading on the substance or by obtaining readings from trusted parties like molecular computational identification laboratories (e.g., over network 106).

The comparison of the photonic signal includes comparing the frequency and amplitude of the photonic signal with the frequency and amplitude in a predefined list of photonic signals, e.g., the following pre-defined list is stored in the storage device 108 and compared with the photonic signal received by the scanner:

| Substance Name | Quantity | Frequency | Amplitude |
|---|---|---|---|
| ABC | 1 ml | 130 MHz | 20 nm |

The molecular structure of the substance 170 being analyzed is thus found dynamically. In addition, other information may be stored regarding the substance as it relates to the environment in which it is used. For example, the system 100 may be configured such that records of substances and corresponding treatment plans may be associated with specific physical locations (i.e., areas of a facility in which the substances are used, or separate facilities). As shown in FIG. 3, e.g., a record 304 stores data associated with each substance used in the facility along with the known frequency and amplitude of that substance. The record 304 also stores one or more treatment plans associated with the substance (e.g., a primary treatment plan and a secondary, e.g., if the primary solutions are not immediately available). The record 304 is linked to a record 302 identifying one physical location of the facility and a second record 306 identifying another physical location of the facility. As shown in record 302, e.g., three substances (1, 3, and 11) are identified as being used in that physical location, and two treatment plans (A and F) are associated with the substances. Likewise, as shown in record 306, three substances (1, 2, and 3) are identified as being used in that physical location, and two treatment plans (A and B) are associated with the substances. Having defined the physical locations as such, the system 100 may be configured to ensure that only the necessary solutions are stored and made available for the treatment apparatus 150 located in the physical location (or defined for use by a set of physical locations).

At step 204, the application 110 queries via local memory (e.g., storage device 108) or web services to identify the optimum treatment plan (e.g., disinfecting solution and instructions) required for properly cleansing the identified substance 170. The disinfecting solution is then prepared from the ingredients attached to the treatment apparatus 150, e.g., in separate contains (shown as solutions 126) at step 206. The solutions may include cleaning solvents, acid solutions, water, etc. In an exemplary embodiment, the treatment apparatus 150 automatically prepares appropriate disinfectants with various concentrations of chemical cleaners, water and other chemicals according to the treatment plan. The apparatus 150 prepares the best possible disinfectant from available ingredient solutions or applies existing chemical cleaner and sprays on the washed object.

The system 100 can further alert the user (e.g., the user of user device 102 or the individual whose hands have been scanned via the treatment apparatus 150) via a visual display (e.g., a display screen of the user device 102 or a separate display on the treatment apparatus (not shown)) if the appropriate disinfectant is not available with the apparatus and suggest alternatives for the same, and facilities in the area which make the treatment available.

At step 208, the treatment plan is implemented via the applicator 130.

The treatment apparatus 150 may complete the process by spraying water after the right amount of time the user has scrubbed hands together.

The exemplary substance identification and nullification determines and applies specific treatments defined for a substance that uses no more solutions than is necessary to nullify the targeted substance. This provides a cost benefit as compared to treatments that over treat substances “as a matter of caution.” This solution provides health benefits in that potentially unnecessary and hazardous solutions are not used and is also eco-friendly.

The exemplary substance identification and nullification processes provide a dynamic repository of substances and treatments as newly classified substances (e.g., carcinogens, pathogens) are discovered and/or corresponding treatments are ascertained. The tags enable multiple different substances to be detected and identified in a signal scanning instance thereby saving time and effort in implementing corresponding treatments.

Various advantages may be realized through the implementation of the substance identification and nullification processes described herein. For example, in states that have adopted the 1999-2005 FDA Food Code governing restaurant food safety requirements, the substance identification and nullification processes and system provide a suitable alternative to glove use and can save thousands of dollars per location every year while maintaining quality and food safety. The substance identification and nullification processes may also provide compliance with many standards Occupational Safety & Health Administration, Centers for Disease Control (CDC) Universal Precautions, etc. The substance identification and nullification processes may further save thousands of dollars in health care services by reducing chemical infections and diseases and reducing wastage of expensive cleansing solutions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product 500 embodied in one or more computer readable medium(s) 502 having computer readable program code embodied thereon 504.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for implementing substance identification and nullification processes, the method comprising:
identifying a substance on an object, the substance determined to be associated with a health risk;
identifying a treatment plan for nullifying the substance, the treatment plan prescribing at least one solution and instructions for nullifying the substance using the at least one solution;
preparing the at least one solution identified in the treatment plan; and
implementing the treatment plan with respect to the object.

2. The method of claim 1, wherein identifying the substance comprises:
preparing a composite material that includes the substance with fluorescent dyes prior to using the composite material in an environment;
receiving a photonic signal emitted from the object in response to scanning the object, the photonic signal having a frequency and amplitude;
comparing the photonic signal to a database of photonic signals for known substances; and
identifying the substance in response to the comparing by matching the frequency and amplitude of the photonic signal to a frequency and amplitude of a photonic signal stored in the database.

3. The method of claim 1, wherein identifying the substance comprises:
applying fluorescent dyes to a surface of the object subsequent to using the composite material in an environment;
receiving a photonic signal emitted from the object in response to scanning the object, the photonic signal having a frequency and amplitude;
comparing the photonic signal to a database of photonic signals for known substances; and
identifying the substance in response to the comparing by matching the frequency and amplitude of the photonic signal to a frequency and amplitude of a photonic signal stored in the database.

4. The method of claim 1, wherein identifying a treatment plan comprises:
looking up the substance in a database of treatment plans, the treatment plans including solutions and instructions for nullifying the substance; and
matching the substance to a substance in the database corresponding to the treatment plan.

5. The method of claim 4, wherein implementing the treatment plan comprises:
preparing solutions identified in the treatment plan and applying the solutions to the object according to the instructions.

6. The method of claim 1, further comprising:
mapping a treatment plan to a physical location in the environment within which a substance is used and storing solutions of the treatment plan at a treatment apparatus situated in the corresponding physical location.

7. A system for implementing substance identification and nullification processes, the system comprising:
a computer processor;
an application executing the computer processor, the application identifying a substance on an object, the substance determined to be associated with a health risk, and the application identifying a treatment plan for nullifying the substance, the treatment plan prescribing at least one solution and instructions for nullifying the substance using the at least one solution; and
a treatment apparatus in communication with the computer processor, the treatment apparatus preparing the at least one solution identified in the treatment plan, and implementing the treatment plan with respect to the object.

8. The system of claim 7, wherein the treatment apparatus further includes an applicator and a sensor in proximity of the applicator, wherein implementing the treatment plan includes sensing the presence of the object near the applicator, and implementing the treatment plan in response to sensing the presence of the object.

9. The system of claim 7, wherein the treatment apparatus comprises an applicator and a scanner, and wherein the identifying the substance comprises:
preparing, via the applicator, a composite material that includes the substance with fluorescent dyes prior to using the composite material in an environment;
receiving, at the computer processor from the scanner, a photonic signal emitted from the object in response to scanning the object by the scanner, the photonic signal having a frequency and amplitude;
comparing, via the application executing on the computer processor, the photonic signal to a database of photonic signals for known substances; and
identifying, via the application, the substance in response to the comparing by matching the frequency and amplitude of the photonic signal to a frequency and amplitude of a photonic signal stored in the database.

10. The system of claim 7, wherein the treatment apparatus comprises an applicator and a scanner, and wherein the identifying the substance comprises:
applying, via the applicator, fluorescent dyes to a surface of the object subsequent to using the composite material in an environment;
receiving, at the computer processor from the scanner, a photonic signal emitted from the object in response to scanning the object by the scanner, the photonic signal having a frequency and amplitude;
comparing, via the application executing on the computer processor, the photonic signal to a database of photonic signals for known substances; and
identifying, via the application, the substance in response to the comparing by matching the frequency and amplitude of the photonic signal to a frequency and amplitude of a photonic signal stored in the database.

11. The system of claim 7, wherein identifying a treatment plan comprises:
looking up the substance in a database of treatment plans, the treatment plans including solutions and instructions for nullifying the substance; and
matching the substance to a substance in the database corresponding to the treatment plan.

12. The system of claim 11, wherein the treatment apparatus includes a solution preparation component and an applicator, and wherein implementing the treatment plan comprises:
preparing, via the solution preparation component, solutions identified in the treatment plan and applying, via the applicator, the solutions to the object according to the instructions.

13. The system of claim 7, wherein the method further comprises:
mapping a treatment plan to a physical location in the environment within which a substance is used and storing solutions of the treatment plan at the treatment apparatus situated in the corresponding physical location.

14. The system of claim 13, further comprising:
a database storing records of known substances, treatment plans, and physical locations of the environment.

15. A computer program product for implementing substance identification and nullification processes, the computer program product including a computer-readable storage medium having instructions embodied thereon, which when executed by a computer cause the computer to implement a method, the method comprising:
identifying a substance on an object, the substance determined to be associated with a health risk;
identifying a treatment plan for nullifying the substance, the treatment plan prescribing at least one solution and instructions for nullifying the substance using the at least one solution;
preparing the at least one solution identified in the treatment plan; and
implementing the treatment plan with respect to the object.

16. The computer program product of claim 15, wherein identifying the substance comprises:
preparing a composite material that includes the substance with fluorescent dyes prior to using the composite material in an environment;
receiving a photonic signal emitted from the object in response to scanning the object, the photonic signal having a frequency and amplitude;
comparing the photonic signal to a database of photonic signals for known substances; and
identifying the substance in response to the comparing by matching the frequency and amplitude of the photonic signal to a frequency and amplitude of a photonic signal stored in the database.

17. The computer program product of claim 15, wherein identifying the substance comprises:
applying fluorescent dyes to a surface of the object subsequent to using the composite material in an environment;
receiving a photonic signal emitted from the object in response to scanning the object, the photonic signal having a frequency and amplitude;
comparing the photonic signal to a database of photonic signals for known substances; and
identifying the substance in response to the comparing by matching the frequency and amplitude of the photonic signal to a frequency and amplitude of a photonic signal stored in the database.

18. The computer program product of claim 15, wherein identifying a treatment plan comprises:
looking up the substance in a database of treatment plans, the treatment plans including solutions and instructions for nullifying the substance; and
matching the substance to a substance in the database corresponding to the treatment plan.

19. The computer program product of claim 18, wherein implementing the treatment plan comprises:
preparing solutions identified in the treatment plan and applying the solutions to the object according to the instructions.

20. The computer program product of claim 15, wherein the method further comprises:
mapping a treatment plan to a physical location in the environment within which a substance is used and storing solutions of the treatment plan at a treatment apparatus situated in the corresponding physical location.
